(19) United States
(12) Patent Application Publication
(10) Pub. No.: US 2026/0319201 A1
(43) Pub. Date: Oct. 15, 2026

(54) Optical Transceiver Assembly for Improved De-latching

(71) Applicants: Albert T. Yuen, Palo Alto, CA (US); Paul K. Rosenberg, Santa Cruz, CA (US)

(72) Inventors: Albert T. Yuen, Palo Alto, CA (US); Paul K. Rosenberg, Santa Cruz, CA (US)

(21) Appl. No.: 19/569,471

(22) Filed: Mar. 17, 2026

Related U.S. Application Data
(60) Provisional application No. 63/788,367, filed on Apr. 14, 2025.

(51) Int. Cl. G02B 6/42; H01R 13/633

(52) U.S. Cl. CPC G02B 6/4278; G02B 6/424; H01R 13/633

(57) ABSTRACT

A system for de-latching optical transceivers includes (A) a magnetic rod; (B) an optical transceiver with a first portion that terminates in an optical ferrule, and a second portion, meeting the first portion at a bend angle within a bend region, that terminates in a connector designed to latch into a socket; and (C) a strap. The strap is attached at a first end to an external surface of the first portion, within the bend region, and attached at a second end to a magnetizable loop. When the optical transceiver is latched into the socket, part of the loop overlies the strap, and the strap overlies the external surface of the first portion of the optical transceiver.

### CROSS-REFERENCES TO RELATED APPLICATIONS

This application claims priority from U.S. Provisional Patent Application Ser. No. 63/788,367 titled “Optical Transceiver Assembly for Improved De-latching”, filed on Apr. 14, 2025, which is hereby incorporated by reference as if set forth in full in this application for all purposes

### FIELD OF INVENTION

This invention relates to the general field of fiber-optic communications components, and in particular to latching and de-latching optical transceivers from sockets.

### BACKGROUND

It is sometimes necessary to connect an optical transceiver into one socket in an array of electrical sockets connected, in some cases via an edge connector, to an ASIC chip on a line card, and subsequently to disconnect an optical transceiver from such a socket. Typically, the line card would be oriented horizontally, such that the sockets face upwards, and the data signals passing between the optical transceiver and the line card circuitry travel vertically up or down the lower portion of the transceiver. However, other line card orientations are possible, such as having the line card vertical, with socket openings facing laterally outwards, so the data signals would travel horizontally to move between the transceiver and the socket. For simplicity, the embodiments illustrated herein and described below assume the former, horizontal line card arrangement of components. It should be appreciated that in all cases relevant to the present invention, the data signals enter the line card sockets in a direction orthogonal to the plane of the line card.

Consider the prior art optical transceiver shown in FIG. 1. To make a connection to a socket of a chip on an underlying line card (socket, chip and line card omitted from the illustration for simplicity) optical transceiver 100 would have to be pushed vertically downwards into that socket, with the optical fiber ferrule or ribbon 110 emerging from the top end of the transceiver, and capable of bending above that point to the extent necessary to conveniently reach and connect to external components.

In prior art, the external shape of the optical transceiver housing often approximates a rectangular prism, so although there may be some irregularities, such as protruding or recessed surface features involved in the latching or de-latching processes, the transceiver may be roughly characterized as having a single linear axis, which in the simplified representation of a prior art transceiver 100, shown on the left side of FIG. 1, would be parallel to the dashed line A-A′. In this particular case, the fiber ferrule or ribbon 110 emerges vertically as shown from the top end of transceiver 100. The dashed arrow points to the unshown socket into which the bottom end of transceiver 100 is pushed down and securely latched during operation, and from which it may be de-latched and pulled vertically upwards when required. This reversible attachment of the transceiver to the socket may involve any of a variety of standard latching mechanisms, with de-latching occurring if and when the top end of transceiver 100 is firmly grasped laterally, for example at positions X and Y on front and rear faces in the orientations shown and then pulled upwards to lift the transceiver straight out of the socket.

In some cases, the latch mechanism may involve moving a wedge-shaped feature on the housing of the transceiver to interact with an edge of a corresponding opening in a vertical face of the socket, or with a lip or protrusion near that opening, resulting in the transceiver fitting firmly into the socket or being released therefrom as desired, but many other mechanical options for achieving these states are well known. The latching features would be present on a surface near the lower end of the transceiver housing, which is configured to fit into the underlying socket. Examples are shown in FIGS. 5 and 6.

In prior art instances of particular interest to the present invention, the shape of the transceiver housing differs from a rectangular prism by incorporating a bend at a fixed angle, typically of about 90 degrees, so that the lower part of the transceiver may be pushed down vertically into the socket, but the upper part is angled away from vertical, and the fiber ferrule¹ exits the transceiver at that same bend angle, at or close to horizontal, as it emerges from the transceiver. In some cases, the optical transceiver may be designed such that the fixed bend occurs at a predetermined distance from the ends, such that when the transceiver is latched into a socket on the surface of the line card, there is a space of sufficient height above the board in the line card to allow a heatsink or another functional component on the board to fit underneath the more horizontal portion of the transceiver. Latching and de-latching features of any of the types mentioned above with respect to the “straight” transceiver designs may of course be present on the lower portions of these “bent” transceivers and function in essentially the same ways. ¹ used hereafter to include ribbon or other fiber assembly, for convenience

However, in the relatively common situations when there are multiple optical transceivers either “straight” or “bent” connected to a tightly packed array (linear or 2-dimensional) of sockets, it may be difficult for the user to reach down to any single transceiver to grasp opposing lateral faces and lift that transceiver out without disturbing or even first detaching one or more other adjacent transceivers that are already latched into adjacent sockets.

There is therefore a need for an improved transceiver design that allows a single transceiver that is securely plugged into a socket in an array of sockets on a board in the line card to be easily detached from that socket, even when there is minimal or zero access to lateral external faces of that transceiver.

### BRIEF DESCRIPTION OF DRAWINGS

FIG. 1 (Prior Art) shows simplified perspective views of two optical transceivers of different geometries, in typical operational orientations.

FIG. 2 (Prior Art) shows simplified perspective views of three optical transceivers in a linear array, illustrating the problem of access for de-latching.

FIG. 3 shows a simplified perspective view of an optical transceiver according to some embodiments of the present invention.

FIG. 4 shows simplified perspective views of the optical transceiver of FIG. 3 at three stages of a sequence for de-latching from an underlying socket according to some embodiments of the present invention.

FIG. 5 shows perspective views of an optical transceiver at three stages of a sequence of latching into an underlying socket according to some embodiments of the present invention.

FIG. 6 shows one perspective view at two levels of magnification of the optical transceiver of FIG. 5 after being latched into the socket.

FIG. 7 shows perspective views of four stages of de-latching an optical transceiver from a linear array of latched transceivers according to some embodiments of the present invention.

### DETAILED DESCRIPTION

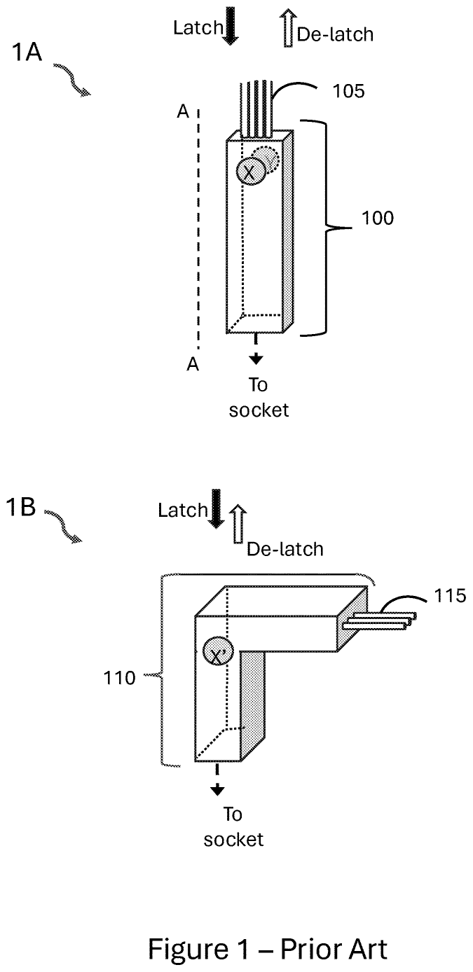

View 1A on the left in FIG. 1 is a simplified perspective view of a “straight” transceiver 100 which may be inserted into an underlying socket (not shown) by being pushed down in the direction indicated by the solid arrow labeled “Latch” above the transceiver. As noted above, in this exemplary case, the fiber ferrule 105 is securely attached to the top end of transceiver 100 and emerges from it in a vertical orientation. If there is enough access to vertical external faces, de-latching can be achieved if and when the top end of transceiver 100 is firmly grasped at opposing side faces, for example at positions X and Y on front and rear faces in the orientations shown, before an upwards pull in the direction indicated by the hollow arrow labeled “De-latch” lifts the transceiver out of the socket.

View 1B on the right in FIG. 1 is a simplified perspective view of another exemplary transceiver 110 whose housing incorporates a 90 degree bend, so only a lower portion of the transceiver is oriented vertically when the transceiver is latched into socket 102, by being pushed down in the direction indicated by the solid arrow labeled “Latch”, while the upper portion of the transceivers is oriented horizontally. In some other embodiments (unshown) the housing may incorporate a bend angle other than 90 degrees. De-latching these transceivers again requires a lateral grasp (for example at position X′ on its front face and a corresponding position on its back face (unshown) followed by an upwards lift (pulling up in the direction indicated by the hollow arrow labeled “De-latch”).

The present invention is directed towards arrangements that use “bent” optical transceivers of the type shown in FIG. 1B, or more broadly to similar types where the bend angle may have a value other than 90 degrees) Such “bent” transceivers are often preferred over those using “straight” ones, for in effect taking up less of the valuable “real estate” on top of the board in the line card. allowing for tighter spacings of components.

In many cases, practical considerations may favor a horizontally positioned line card, with a corresponding horizontal layout of upward facing sockets, over a vertically positioned line card with an array of lateral facing sockets, but it should be appreciated that the core inventive ideas presented in the present disclosure would also be applicable and advantageous to line card and socket orientations other than those explicitly discussed and illustrated. As mentioned above in the Background section of this disclosure, there is an orthogonal relationship between the plane of the line card and the direction of travel of data signals at the transceiver-socket junction in embodiments of interest to the present invention. This means that the data signals crossing that junction travel in a vertical direction in the more typical cases where the line card is horizontal, but in a horizontal direction in those cases where the line card is vertical.

As also mentioned above in the Background section, the mechanical de-latching process (grasp then pull out at right angles to the top surface of the line card) indicated in FIG. 1 can be achieved by simple manual means when only a single transceiver is involved. In more typical situations, involving close packed arrangements of a linear array of transceivers in a corresponding linear array of sockets, there may simply not be enough room to access the side faces and then apply the required forces.

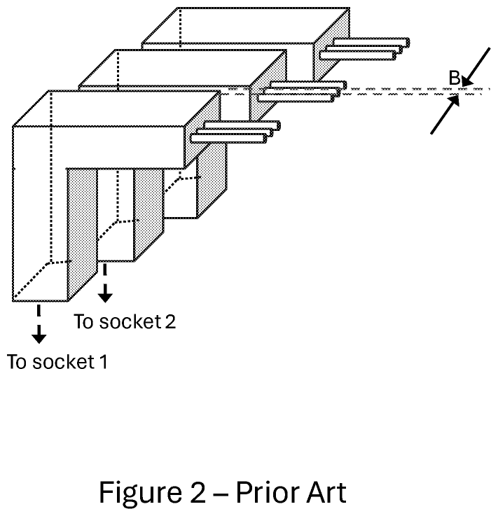

FIG. 2 (prior art) is a simplified perspective view of part of a linear array of L-shaped (bend angle 90 degrees) transceivers positioned over a corresponding array of sockets (not shown). The important point to note is that for a desirably close-packed arrangement, the size of the gap B between the side faces of adjacent transceivers bent may well be too small to allow fingers or a simple tool to be inserted to press against the side faces of a single transceiver and then pull it out of its socket, if and when required.

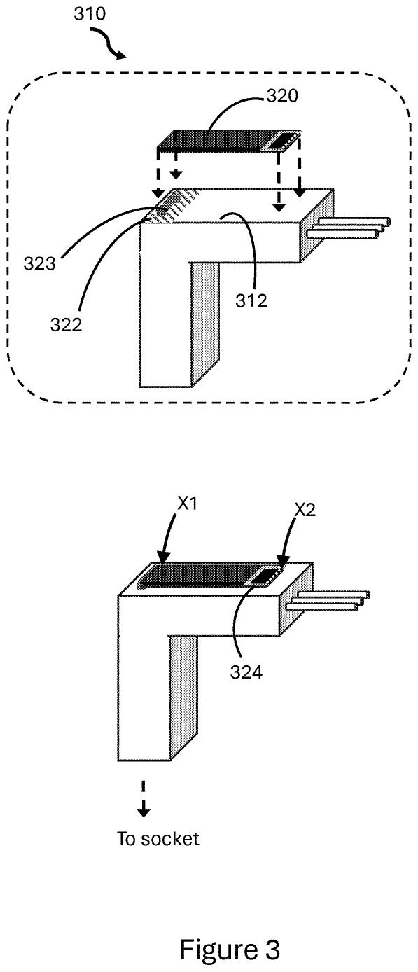

FIG. 3 is a simplified perspective view of an L-shaped (bend angle 90 degrees) transceiver 310, that includes features that enable this problem of limited lateral access for de-latching to be overcome, according to some embodiments of the present invention. Transceiver 310 is shown in a partially “exploded” view on the left, within the dashed outline, and in a “collapsed” view, as it appears in its default assembled state, to the right. On top of a horizontal surface 312 of the transceiver lies a strap 320. Close to the bend in the transceiver, within a region 322 roughly indicated by hatching² and referred to hereafter as a “bend region”, is a bar 323, firmly attached to, or fabricated as part of, the transceiver housing. The bar may lie slightly above the horizontal top surface 312 as shown, or in other embodiments lie slightly below that surface in a recess (not shown). One end of strap 320 is attached to bar 323 in a way that allows for rotational movement of the strap around the horizontal axis of the bar—for example, the rear end of the strap may be wrapped around the bar and glued back to the underside of the strap (at a position indicated by a dashed white line labeled X1 in the view on the right of the figure) to form a loose tube enclosing and hiding at least part of the bar. The other end of the strap is attached to a loop 324 of magnetizable material such as iron, in a way that allows for rotational movement of the strap around the horizontal axis of a straight portion of the loop parallel to the long axis of the bar—for example, the front end of the strap may be wrapped around on such portion of the loop, and glued back to the top surface of the strap (at a position indicated by a dashed white line labeled X2 in the view on the right of the figure) to form another loose tube. The remainder of loop 324, not covered by the very end of strap 320, lies exposed on top of strap 322. ² The bend region is not explicitly indicated by labeling or hatching in subsequent figures, for simplicity.

In the shown embodiment, loop 324 has a flat rectangular shape, with three side portions of the loop exposed while the front portion, closest to the fiber ferrule, is largely hidden from view by strap 320.

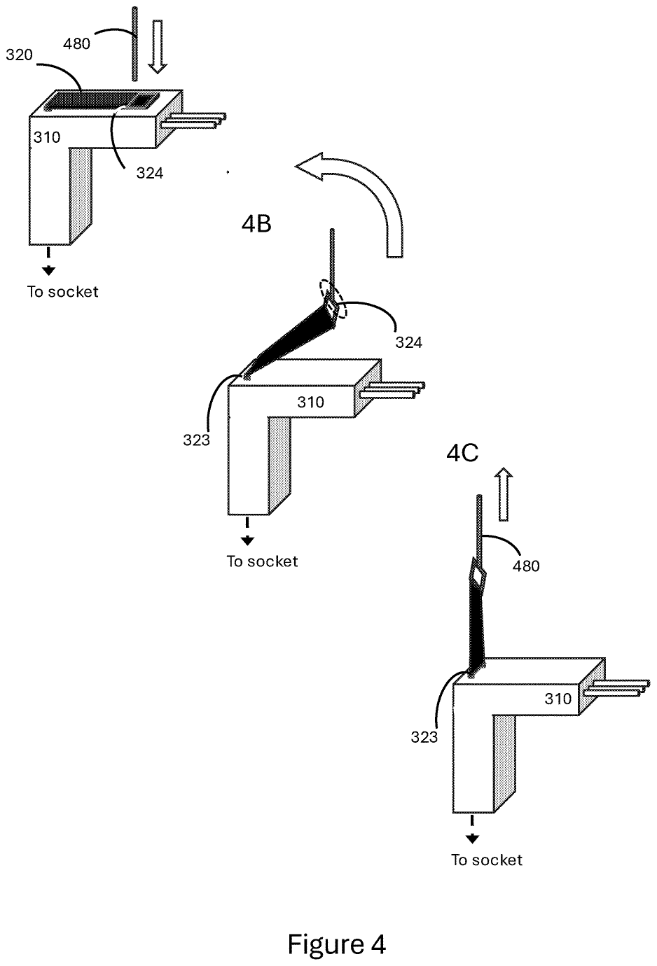

FIG. 4 illustrates a sequence of three stages (4A, 4B, 4C,) of a de-latching process for a single transceiver of the present invention, such as transceiver 310 shown in FIG. 3. At the first stage 4A, a rod 480 comprising a magnet is lowered towards the upper surface of strap 330 (which lies on upper surface 312 of transceiver 310) and approaches loop 324. In some embodiments, as shown, rod 430 may be significantly narrower than the width of the transceiver, or that of the strap, but in other embodiments, this may not necessarily be the case.

View 4B shows a slightly later stage of the de-latching process, after rod 480 was first brought close enough to an exposed portion indicated by the dashed oval) of loop 324 for magnetic attraction between rod 480 and that part of the loop to pull the tip of the rod and that portion of the loop into contact, and then lifted and moved towards the left in the orientation shown in the figure, following an arc approximately indicated by the hollow arrow. At this “4B” stage, that movement of the rod has caused the magnetically attracted loop 324 (typically but not necessarily made of iron) to also rise up and move to the left, bringing the strap 330, to which it is attached, along with it as shown. View 4C shows a third stage of the process, where continued motion of the rod along has pulled loop 324 and attached strap 330 into an approximately vertical orientation, while the left hand end of the strap remains attached to bar 322. At this point, rod 480 may be pulled vertically upwards in the direction indicated by the hollow arrow in view 4C, bringing with it the magnetically attracted loop with which it is in contact, and the strap to which the loop is securely attached. The vertical pulling force exerted in this way acts on the transceiver to which the strap is attached via bar 322, first de-latching whatever mechanism was holding the transceiver in place in an underlying socket (not shown), and then lifting the transceiver out of that socket.

It should be noted that this whole process only requires access from above the transceiver and socket, not from either side. Therefore, in situations where multiple such transceivers are present, latched into a corresponding array of sockets, even in a closely packed arrangement like that illustrated in FIG. 2, de-latching and removal of a single transceiver in that array can be conveniently carried out from above, without any struggle to insert fingers or other tools between that transceiver and its nearest neighbor or neighbors.

In the embodiments shown in FIGS. 3 and 4, the initiating force is based on applying a magnetic force from a rod or similar simple tool approaching from above to move specific mechanical elements attached to a top surface of a transceiver to enable removal of that transceiver from an underlying socket to which it is connected.

In some other embodiments, the force exerted by the tool may not be magnetic. Instead of comprising a magnet, the tool may, for example, be a rod that terminates in a hook or other simple mechanical structure, either formed into or securely attached to that rood. In such a case, there would be a corresponding “eye” or other suitable mating structure on the strap, to which that hook could be reversibly mated. The rest of the steps involved would be the same as those described above with respect to FIG. 4. The mating structure could even be an iron loop as mentioned above, though of course it could be made of a non-magnetizable metal, or even a non-metallic material as long as it is sufficiently rigid for repeated latching and de-latching to occur as desired.

It should be noted that while magnetic or other lifting mechanisms that use a strap or strap-like structure to de-latch transceivers from sockets work particularly well for transceiver designs that include 90 degree bends and a substantial horizontal area for positioning such structures, as discussed in detail above, such lifting mechanisms may also be useful where the bend angle differs from that value within a small range—maybe plus or minus 30 degrees—as long as the strap by default lies against the top surface of the upper part of the optical transceiver, able to be accessed by a rod approaching from above, and then rotated and pulled upwards by interaction with that rod, when de-latching and removal of the transceiver is required.

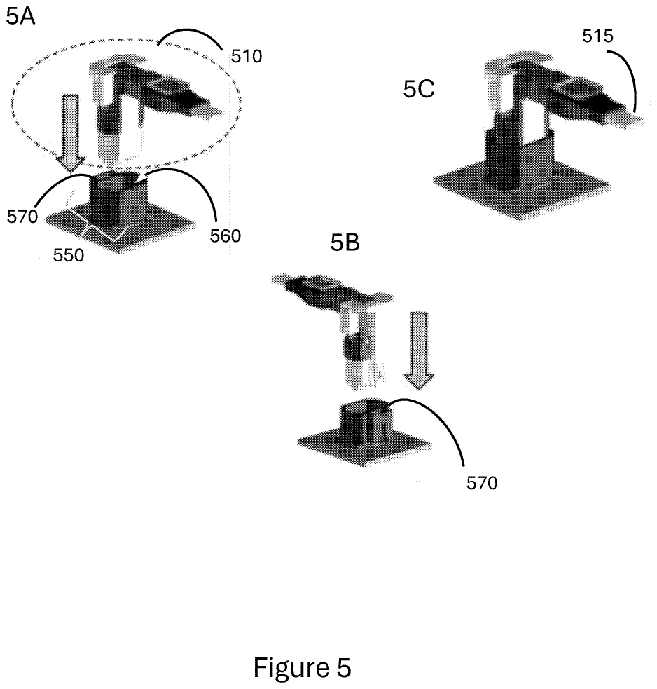

FIGS. 5-7 are more detailed illustrations of transceivers and sockets according to some embodiments of the present invention, showing a variety of views prior to connection, after connection, and at different levels of magnification illustrating aspects of de-latching according to some embodiments of the present invention.

View 5A at the top left of FIG. 5 illustrates a transceiver 510 with attached fiber ferrule 515, positioned above socket 550. Transceiver 510 is shown in position to be latched into underlying socket 550 by being pushed vertically down in the direction of the solid arrow. Socket 550 contains a primary opening 560 within which functional electrical connections between transceiver and socket may be established, and a secondary pocket 570 central to the mechanical latching and de-latching operations of this particular embodiment. Moving towards the center of the figure, view 5B illustrates the same situation from a viewpoint rotated by 180 degrees. At the top right, view 5C shows transceiver 510 securely latched into socket 550, from the same viewpoint as that of view 5A, with different parts of the lower portion of the transceiver accommodated by opening 560 and pocket 570 respectively.

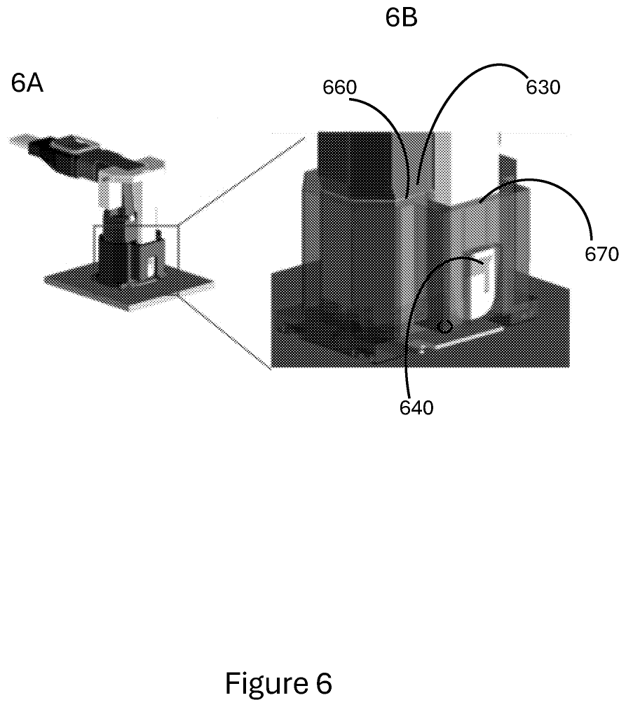

View 6A at the left of FIG. 6 shows transceiver 510 latched into socket 550 as in view 5B of FIG. 5, but rotated a further 180 degrees. View 6B is a magnified view of part of view 5A to better illustrate features involved in latching. In brief, while the bulk of the lower portion 630 of the transceiver, containing its core opto-electronic circuitry fits into opening 660, another portion (shown white in the figure) fits into pocket 670, where a wedge-shaped latching feature 640 of the type discussed above serves to hold the transceiver securely in place.

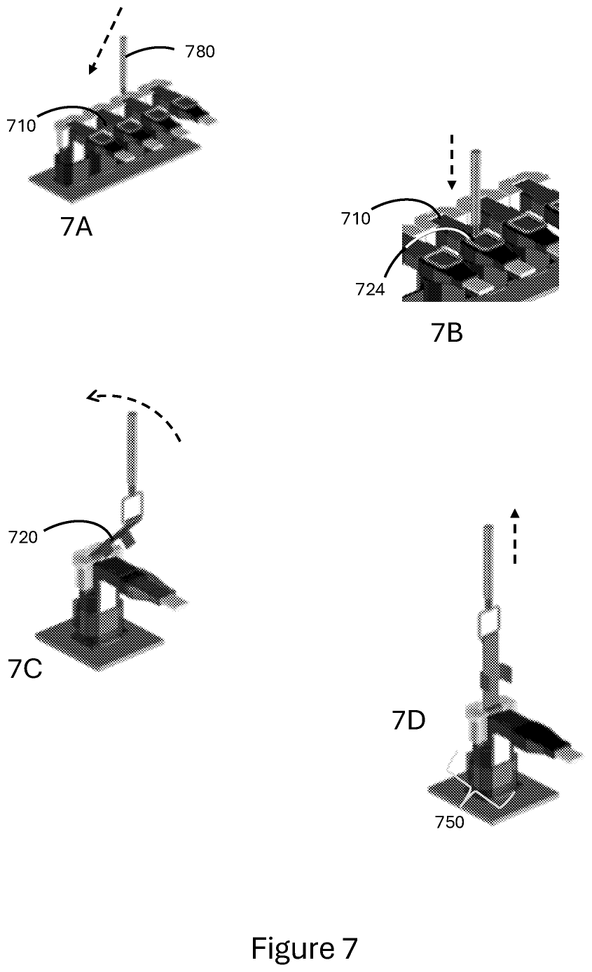

Views 7A and 7B of FIG. 7 show a linear array of optical transceivers latched into their sockets, illustrating a situation where it is desired to remove the second transceiver from the left, 710, without disturbing any of the others. View 7A shows an initial stage, where magnetic rod 780 is brought towards the array from a position above the array, and view 7B shows the rod after it has reached a position directly above the target transceiver, and more particularly directly above and very close to an exposed portion of loop 724 lying against an upper surface of that transceiver. Views 7C and 7D do not show adjacent transceivers for the sake of simplicity, but it should be clear that just as rod 780 can be moved laterally and then downwards to approach loop 724 without disturbing adjacent transceivers, it can then make contact with and pull that loop, and its attached strap 730, through an arc as shown in view 7C and then vertically upwards from the position shown in view 7D, again without disturbing adjacent transceivers.

The embodiments illustrated in this disclosure make use of one particular type of prior art latching mechanism where latching is achieved by pushing a wedge feature of an outward projecting structure on the face of the vertically oriented portion of the transceiver into a side pocket of the corresponding socket past a retaining edge, and de-latching is achieved by applying a vertical force to the transceiver sufficient to lift the wedge out of the side pocket in spite of the retaining edge. However, many other well-established latching and de-latching mechanisms may readily be envisaged. It should also be noted that although the discussion and illustrations disclosed herein focus on linear arrays of transceiver-socket pairs, the present invention could also be applicable to 2-dimensional arrays, given appropriate consideration of the specific shapes and dimensions of the optical transceivers of interest.

In summary, the systems and designs described herein offer ways to allow a single optical transceiver, latched into an underlying socket, to be easily and conveniently de-latched from thar socket and removed, even when there is minimal lateral access to that transceiver, for example if the transceiver-socket pair in question is positioned within a tightly packed array of similar transceiver-socket pairs.

It should be understood that the disclosure teaches just few examples of illustrative embodiments, that many variations of the invention can easily be devised by those skilled in the art after reading this disclosure, and that the scope of the present invention is to be determined by the following claims.

1. A system for de-latching optical transceivers, the system comprising:
a rod comprising a magnet;
an optical transceiver comprising:
a first portion having a first end terminating in an optical fiber ferrule or ribbon; and
a second portion having a second end terminating in a connector configured to securely latch into a socket;
wherein the first and second portions meet at a fixed bend angle at a bend region of the optical transceiver; and
a strap comprising:
a first end attached to an external surface of the first portion of the optical transceiver within the bend region; and
a second end attached to a loop comprising a magnetizable material;
wherein, when the optical transceiver is latched into the socket, at least part of the loop overlies the strap, and the strap overlies the external surface of the first portion of the optical transceiver.

2. The system of claim 1, wherein the fixed bend angle lies between 60 degrees and 120 degrees.

3. The system of claim 2, wherein the fixed bend angle is 90 degrees.

4. The system of claim 3, wherein, when the optical transceiver is latched into a socket connected to an IC chip on a board in a horizontally oriented line card, the first and second portions of the optical transceiver are oriented horizontally and vertically respectively.

5. The system of claim 1, wherein the magnetizable material is iron.

6. A system for de-latching optical transceivers, the system comprising:
an optical transceiver comprising:
a first portion having a first end terminating in an optical fiber ferrule or ribbon; and
a second portion having a second end terminating in a connector configured to securely latch into a socket;
wherein the first and second portions meet at a fixed bend angle at a bend region of the optical transceiver;
a strap comprising:
a first end attached to an external surface of the first portion of the optical transceiver within the bend region; and
a second end attached to a mechanical device;
wherein, when the optical transceiver is latched into the socket, at least a part of the mechanical device overlies the strap, and the strap overlies the external surface of the first portion of the optical transceiver; and
a rod having one end terminating in a hook, configured to reversibly couple with the part of the mechanical device.

7. The system of claim 6, wherein the fixed bend angle lies between 60 degrees and 120 degrees.

8. The system of claim 7, wherein the fixed bend angle is 90 degrees.

9. The system of claim 8, wherein, when the optical transceiver is latched into a socket connected to an IC chip on a board in a horizontally oriented line card, the first and second portions of the optical transceiver are oriented horizontally and vertically respectively.
